(19) United States
(12) Patent Application Publication
(10) Pub. No.: US 2018/0345466 A1
(43) Pub. Date: Dec. 6, 2018

(54) PIPE CRIMPING TOOL

(71) Applicant: SUN-WONDER INDUSTRIAL CO., LTD., Taoyuan City (TW)

(72) Inventor: Chia-Chun CHANG, Taoyuan City (TW)

(21) Appl. No.: 15/990,638

(22) Filed: May 27, 2018

(30) Foreign Application Priority Data
Jun. 2, 2017 (TW) 106118281

(51) Int. Cl. B25B 27/10; B23P 11/00

(52) U.S. Cl. CPC B25B 27/10; B23P 11/005

(57) ABSTRACT

A tube crimper includes a front crimper including a crimper body and multiple crimper wires arranged in a U shape and defining with the crimper body a U-shaped closed space therebetween, a die block mounted in the U-shaped closed space, and a hydraulic device having a pusher inserted through the crimper body of the front crimper and connected with the die block. After insertion of the tube and connector to be crimped into the U-shaped closed space, the hydraulic device is operated to move the pusher, causing the die block and the crimper wires to crimp the tube onto the connector.

### BACKGROUND OF THE INVENTION

### 1. Field of the Invention

The present invention relates to tube crimping technology, and more particularly to a tube crimper that uses a front crimper with crimper wires arranged in U shape to mate with a die block of a selected size for crimping tubes of different diameters.

### 2. Description of the Related Art

A conventional hydraulic crimper generally comprises a crimper body, a pair of C-shaped jaw holders arranged at a front side of the crimper body, and two jaws respectively mounted in respective jaw grooves in the C-shaped jaw holders for crimping a high-pressure tube. After insertion of the high-pressure tube to be crimped in between the two jaws in the two C-shaped jaw holders, the operating handle of the hydraulic crimper is biased, causing the two jaws to crimp the high-pressure tube. However, for crimping a high-pressure tube of a different diameter, the original pair of C-shaped jaw holders must be replaced by a pair of C-shaped jaw holders of a different size. Further, the tightening stress the mating end contact portions of the C-shaped jaw holders can impart is the weakest that cannot positively crimp the high-pressure tube.

### SUMMARY OF THE INVENTION

The present invention has been accomplished under the circumstances in view. It is therefore the main object of the present invention to provide a tube crimper, which is practical for positively crimping tubes of different diameters, saving the cost.

To achieve this and other objects of the present invention, a tube crimper comprises a hydraulic device, a die block and a front crimper. The front crimper comprises a crimper body and a plurality of crimper wires. The crimper wires are arranged in a U shape for crimping, each comprising two opposite end portions respectively fastened to the crimper body. The crimper wires are disposed in parallel so that a U-shaped closed space is defined between the crimper wires and the crimper body. The hydraulic device comprises a pusher that is inserted through the crimper body of the front crimper and connected with the die block in the U-shaped closed space for allowing the crimper wires to be wound round the die block after insertion of the tube with the attached connector into the U-shaped closed space so that the hydraulic device is operable to move the die block and the crimper wires in crimping the tube onto the connector.

Further, the die block is detachably fastened to the crimper body of the front crimper so that different sizes of die blocks can be selectively used for crimping tubes of different diameters. Further, the crimper body of the front crimper comprises a support plate for supporting the loaded die block for positive crimping.

Further, each crimper wire defines an arc segment, two end portions respectively fastened to the crimper body, and two extension segments bilaterally connected between the arc segment and the end portions, where the diameter of the arc segment is larger than or equal to the distance between the two end portions so that the angle of the arc segment winding around the tube is larger than or equal to 180°. Thus, the tightening stress imparted by the crimper wires of the front crimper to the tube can extend over the mating contact area, avoiding stress attenuation and enhancing the crimping effect.

### BRIEF DESCRIPTION OF THE DRAWINGS

FIG. 1 is an exploded view of a tube crimper in accordance with the present invention.

FIG. 2 illustrates the die block connected to the pusher of the hydraulic device before fastening of the positioning block member to the fixed block member.

FIG. 3 illustrates the tube to be crimped held between the crimper wires and the die block before crimping.

FIG. 4 corresponds to FIG. 3 when viewed from another angle.

FIG. 5 illustrates the tube crimped onto the connector.

FIG. 6 is an elevational view of an alternate form of the present invention, illustrating two locating holes formed on the positioning rib of the fixed block member of the crimper body.

FIG. 7 is a schematic drawing illustrating a crimping operation of the alternate form of tube crimper of FIG. 6.

### DETAILED DESCRIPTION OF THE PREFERRED EMBODIMENT

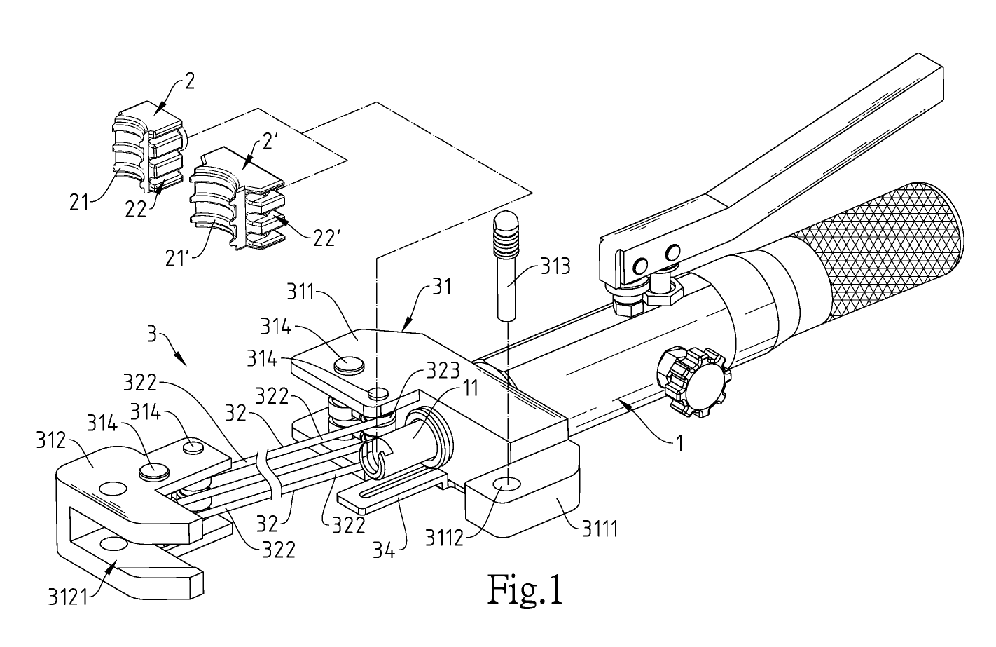

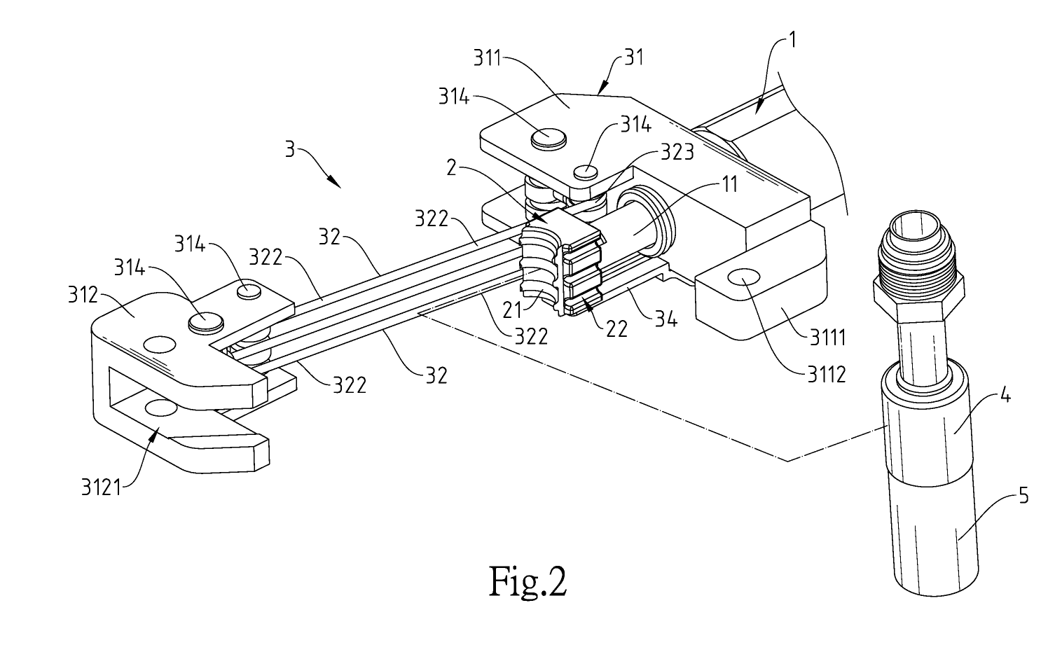

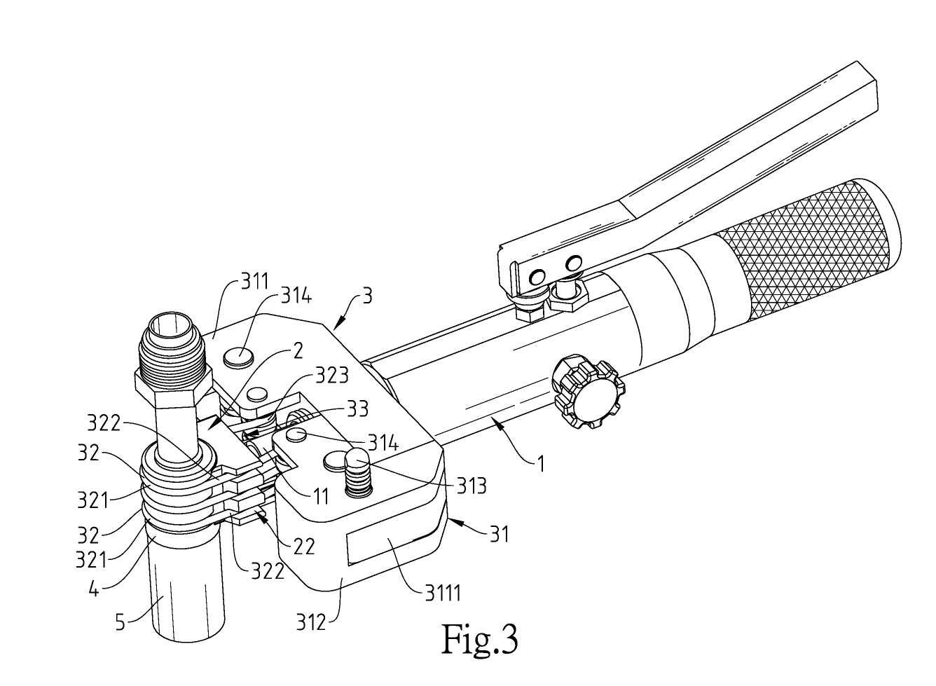

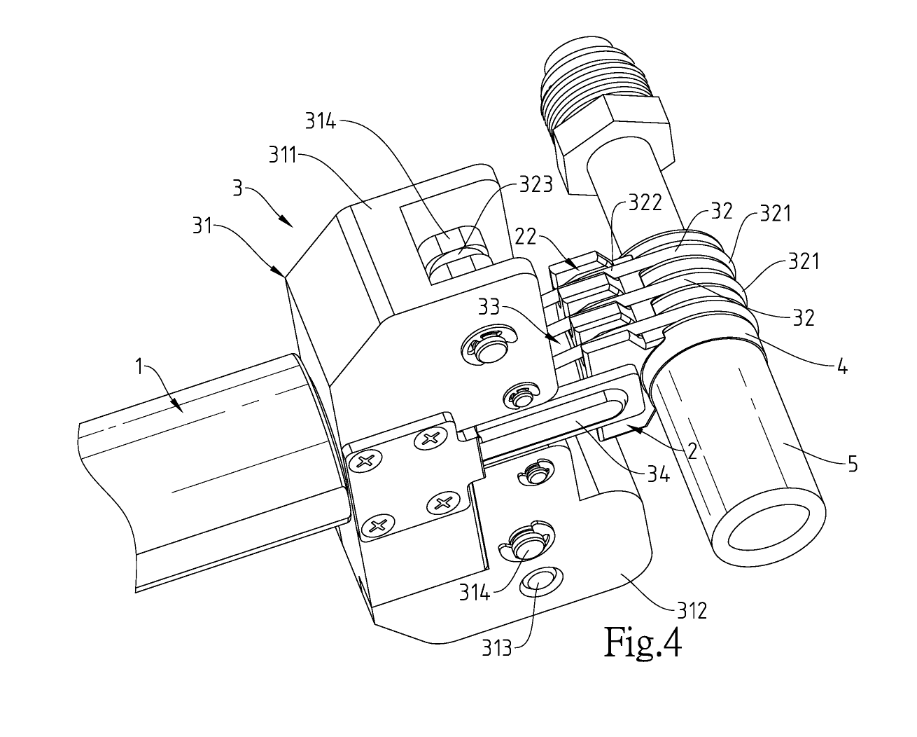

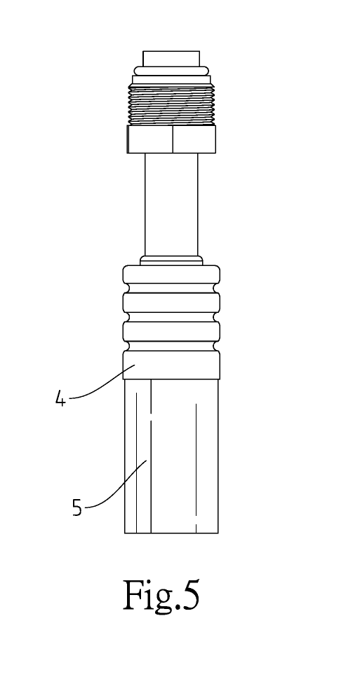

Referring to FIGS. 1-5, a tube crimper in accordance with the present invention is shown. The tube crimper comprises a hydraulic device 1, a die block (2,2′) and a front crimper 3.

The front crimper 3 comprises a crimper body 31 and a plurality of crimper wires 32. In crimping, the crimper wires 32 are arranged in a U shape with respective opposite end portions 323 thereof affixed to the crimper body 31. Further, these crimper wires 32 are arranged in parallel so that a U-shaped closed space 33 is formed between the crimper wires 32 and the crimper body 31. In this embodiment, the end portions 323 of each crimper wires 32 are respectively wound around a respective post 314 in the crimper body 31 and fastened thereto.

The die block (2,2′) is mounted in the U-shaped closed space 33, comprising a plurality of crimping ribs (21,21′). Further, the crimper wires 32 of the front crimper 3 wound round the die blocks (2,2′).

The hydraulic device 1 is fixedly connected to the crimper body 31 of the front crimper 3, comprising a pusher 11 that is inserted through the crimper body 31 of the front crimper 3 and connected with the die block (2,2′). The tube 4 is inserted with the attached connector 5 into the U-shaped closed space 33 between the crimper wires 32 and the die block (2,2′), and then the hydraulic device 1 is operated to extend out the pusher 11, forcing the die block (2,2′) to squeeze the tube 4 against the crimper wired 32, and thus, the tube 4 is crimped and joined to the connector 5.

The crimper body 31 of the front crimper 3 comprises a fixed block member 311 and a positioning block member 312. The fixed block member 311 is connected with one end portion 323 of each crimper wire 32. The positioning block member 312 is connected to the other end portion 323 of each crimper wire 32. The positioning block member 312 and the fixed block member 311 are detachably connected together.

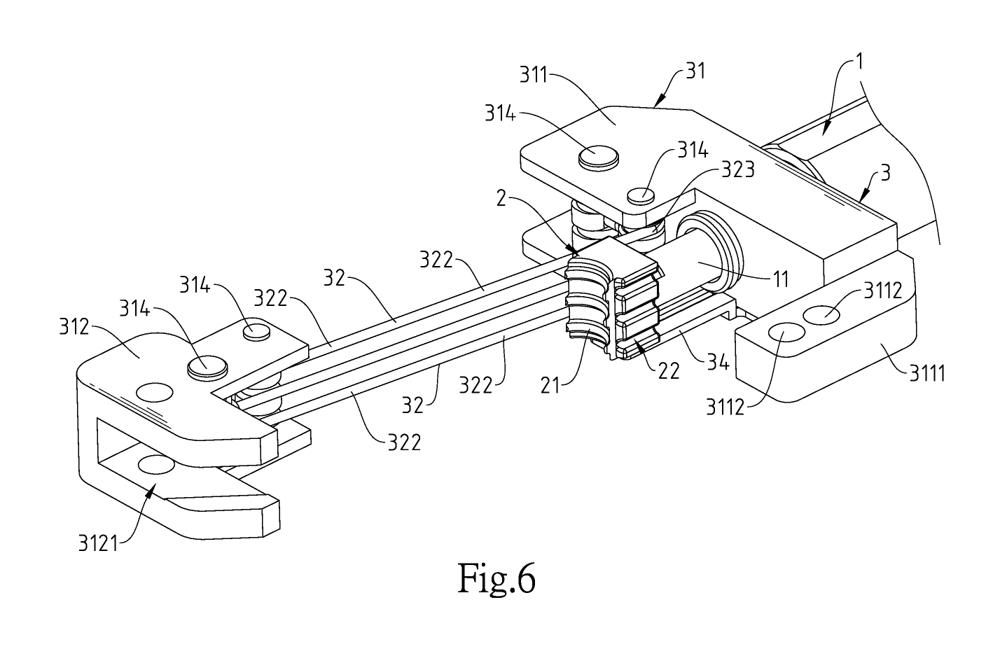

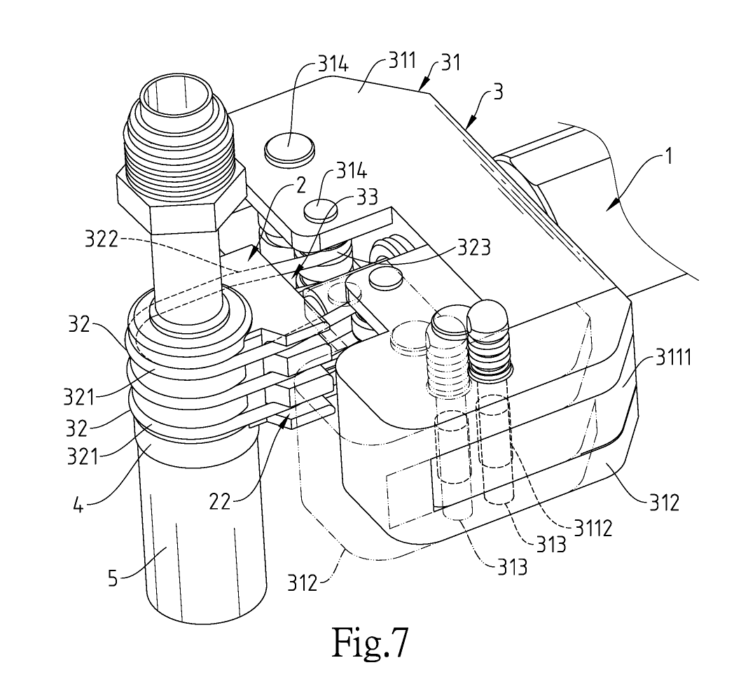

Referring to FIGS. 6 and 7 and FIGS. 1-4 again, the fixed block member 311 of the crimper body 31 comprises a positioning rib 3111, and at least one locating hole 3112 located on the positioning rib 3111. The positioning block member 312 comprises a coupling open chamber 3121. In installation, the positioning rib 3111 of the fixed block member 311 is inserted into the coupling open chamber 3121 of the positioning block member 312, and then a locating pin 313 is mounted in one locating hole 3112 of the positioning rib 3111 to fasten the fixed block member 311 and the positioning block member 312 together. In the embodiment shown in FIGS. 6 and 7, the positioning rib 3111 is configured to provide multiple locating holes 3112. The locating pin 313 is selectively mounted in one of the locating holes 3112 to fasten the fixed block member 311 and the positioning block member 312 together.

In application, separate the positioning block member 312 from the fixed block member 311 of the crimper body 31 of the front crimper 3, then insert the tube 4 with the attached connector 5 into the U-shaped closed space 33 between the crimper wires 32 and the die block (2,2′), and then attach the positioning block member 312 to the fixed block member 311, and then fasten the locating pin 313 to the selected locating hole 3112 to lock the positioning block member 312 to the fixed block member 311, holding the tube 4 in the U-shaped closed space 33 between the crimper wires 32 and the die block (2,2′), and then operate the hydraulic device 1 to extend out the pusher 11 in forcing the die block (2,2′) against the tube 4 and the crimper wires 32, thereby crimping the tube 4 against the connector 5. Thus, the tube 4 is deformed and fixedly secured to the connector 5.

By means of selectively fastening the locating pin 313 to one of the locating hole 3112, different sizes of die blocks (2,2′) can be selectively used according to the diameter of the tube 4 to be crimped. Thus, different sizes of die blocks (2,2′) can be selectively mated with the crimper wires 32 of the front crimper 3 to crimp tubes 4 of different diameters, saving the cost.

In addition to the crimping ribs (21,21′), the die block (2,2′) further comprises a plurality of guide grooves (22,22′) for accommodating and guiding the crimper wires 32, avoiding displacement of the crimper wire 32 during crimping. Further, the crimper body 31 of the front crimper 3 further comprises a support plate 34 forwardly extended from a bottom side thereof for supporting the loaded die block (2,2′) for positive crimping.

When the crimper wires 32 are arranged in a U shape during the crimping operation, each crimper wire 32 defines an arc segment 321, the aforesaid two end portions 323 that are fastened to the crimper body 31, and two extension segments 322 bilaterally connected between the arc segment 321 and the end portions 323, where the diameter of the arc segment 321 is larger than or equal to the distance between the two end portions 323 so that the angle of the arc segment 321 winding around the tube 4 is larger than or equal to 180°. Thus, the tightening stress imparted by the crimper wires 32 of the front crimper 3 to the tube 4 can extend over the mating contact area, avoiding stress attenuation and enhancing the crimping effect.

What the invention claimed is:

1. A tube crimper comprising a hydraulic device, a die block and a front crimper for crimping a tube onto a connector, said front crimper comprising a crimper body and a plurality of crimper wires, said crimper wires being arranged in a U shape for crimping, each said crimper wire comprising two opposite end portions respectively fastened to said crimper body, said crimper wires being disposed in parallel so that a U-shaped closed space is defined between said crimper wires and said crimper body, said hydraulic device comprising a pusher inserted through said crimper body of said front crimper and connected with said die block in said U-shaped closed space for allowing said crimper wires to be wound round said die block after insertion of said connector and said tube into said U-shaped closed space so that said hydraulic device is operable to move said die block and said crimper wires in crimping said tube onto said connector.

2. The tube crimper front crimper as claimed in claim 1, wherein said crimper body comprises a fixed block member connected with one said end portion of each said crimper wire and a positioning block member connected to the other said end portion of each said crimper wire; said positioning block member is detachably fastened to said fixed block member.

3. The tube crimper front crimper as claimed in claim 2, wherein said fixed block member of said crimper body comprises a positioning rib and at least one locating hole located on said positioning rib; said positioning block member comprises a coupling open chamber detachably coupled to said positioning rib of said fixed block member by locked thereto with a locating pin that is selectively fastened to said at least one locating hole.

4. The tube crimper front crimper as claimed in claim 1, wherein said die block comprises a plurality of guide grooves for accommodating and guiding said crimper wires.

5. The tube crimper front crimper as claimed in claim 1, wherein when said crimper wires are in arranged in said U shape during crimping, each said crimper wire defines an arc segment, the two said end portions and two extension segments that are bilaterally connected between said arc segment and the said two end portions, the diameter of said arc segment being greater than or equal to the distance between the two said end portions so that the angle of arc segment winding around said tube is larger than or equal to 180°.

6. The tube crimper front crimper as claimed in claim 1, wherein said crimper body of said front crimper further comprises a support plate forwardly extended from a bottom side thereof for supporting said die block in said U-shaped closed space.
